(19) United States
(12) Patent Application Publication
(10) Pub. No.: US 2009/0106743 A1
(43) Pub. Date: Apr. 23, 2009

(54) METHODS AND SYSTEMS FOR CONVERTING AUTOMATION SOFTWARE

(76) Inventor: Paul Parisien, Genoa, NV (US)

Correspondence Address: General Electric Company;GE Global Patent Operation, PO Box 861, 2 Corporate Drive, Suite 648, Shelton, CT, 06484, US

(21) Appl. No.: 11/874,386

(22) Filed: Oct. 18, 2007

(51) Int. Cl. G06F 9/45

(52) U.S. Cl. 717/136

(57) ABSTRACT

A method for converting a software environment defined using flat name space into an equipment model is provided. The method includes decomposing the flat name space into a plurality of tokens, and assigning each token to a corresponding level of a plurality of levels included in an equipment hierarchy. The method also includes translating each token into a human-readable name, and creating an equipment model based on the human-readable name and the corresponding level assigned to each token.

### BACKGROUND OF THE INVENTION

This invention relates generally to automation software and, more specifically, to methods and systems for converting automation software.

At least some known automated applications are performed using equipment that is operated by automation software. The automation software includes a software environment that is defined by a user to provide rules and limitations that dictate the automated operation of each piece of equipment used in the automated application. Accordingly, the environment must be defined in a language that is recognized by each piece of equipment. At least some known equipment is configured to recognize a flat name space language and, as such, automation software is commonly defined using flat name space. However, flat name space uses a convoluted naming convention that is often subject to limitations on character lengths and/or a type of character used to define the environment.

Accordingly, at least some automated equipment is designed to operate based on an equipment model that is not subject to many of the limitations that restrict flat name space. However, equipment that is operated using an equipment model is not necessarily compatible with equipment that operates using flat name space. As such, manufacturers and businesses that operate automated systems are required to update an entire system when only a portion of the system requires updates.

### BRIEF DESCRIPTION OF THE INVENTION

In one aspect, a method for converting a software environment defined using flat name space into an equipment model is provided. The method includes decomposing the flat name space into a plurality of tokens, and assigning each token to a corresponding level of a plurality of levels included in an equipment hierarchy. The method also includes translating each token into a human-readable name, and creating an equipment model based on the human-readable name and the corresponding level assigned to each token.

In another aspect, an automated system is provided. The system includes automated equipment and a processor configured to convert a software environment defined using flat name space into an equipment model usable by the automated equipment, wherein the processor converts the software environment by decomposing the flat name space into a plurality of tokens, and assigning each token to a corresponding level of a plurality of levels included in an equipment hierarchy. The processor also translates each token into a human-readable name, and creates the equipment model based on the human-readable name and the corresponding level assigned to each token.

In yet another aspect, a computer program embodied on a computer-readable medium is provided. The computer program includes at least one code segment configured to instruct a computer to convert a software environment defined using flat name space into an equipment model by decomposing the flat name space into a plurality of tokens, and assigning each token to a corresponding level of a plurality of levels included in an equipment hierarchy. The program also includes a code segment configure to instruct a computer to translate each token into a human-readable name, and create the equipment model based on the human-readable name and the corresponding level assigned to each token.

### BRIEF DESCRIPTION OF THE DRAWINGS

FIG. 1 is a schematic view of an exemplary automated system; and

FIG. 2 is a flowchart of an exemplary method for converting automation software that may be used with the automated system shown in FIG. 1.

### DETAILED DESCRIPTION OF THE INVENTION

The present invention provides an automated system including automated equipment that is run by a computer that includes a processor and/or a computer program embodied on a computer-readable medium. A technical effect of the computer is a conversion of a software environment defined using flat name space into an equipment model that is used to operate the automated equipment.

It should be noted that although the present invention is described with respect to automated systems, as will be appreciated by one of ordinary skill in the art, the present invention may also apply to any system and/or equipment that is operated by a software environment defined using flat name space and/or an equipment model. Further, although the present invention is described with respect to processors and computer programs, as will be appreciated by one of ordinary skill in the art, the present invention may also apply to any system and/or program that is capable of converting a software environment. For example, as used herein, the term processor is not limited to just those integrated circuits referred to in the art as processors, but broadly refers to computers, processors, microcontrollers, microcomputers, programmable logic controllers, application specific integrated circuits, and other programmable circuits. The processor may be part of a computer that may include a device, such as, a floppy disk drive or compact disc-read-only memory (CD-ROM) drive, for reading data from a computer-readable medium, such as a floppy disk, a CD-ROM, a magneto-optical disk (MOD), or a digital versatile disc (DVD).

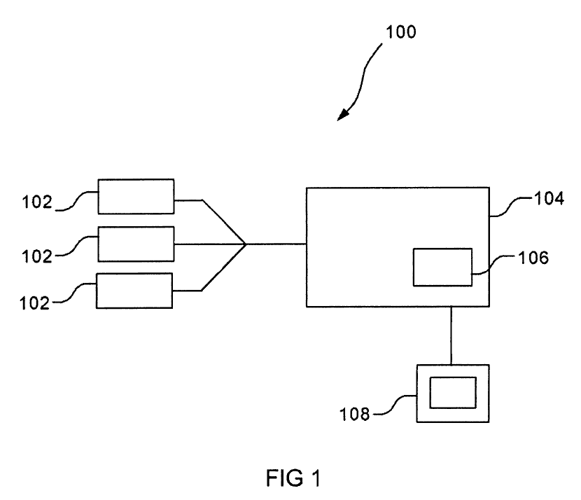

FIG. 1 is a schematic view of an exemplary automated system 100. Automated system 100 includes automated equipment 102 and at least one computer 104 that includes a processor 106 and is electronically coupled to a user interface 108. Although the exemplary embodiment illustrates three pieces of automated equipment 102, as will be appreciated by one of ordinary skill in the art, system 100 may include any suitable number of automated equipment pieces. Further, although computer 104 is illustrated as being electronically coupled to automated equipment 102 and user interface 108, as will be appreciated by one of ordinary skill in the art, computer 104 may be remote from, and wirelessly communicate with, automated equipment 102 and/or user interface 108.

In the exemplary embodiment, processor 106 is configured to run automation software including a program configured to control automated equipment 102. In one embodiment, the automation software is embodied in a program embodied on a computer-readable medium. Further, in the exemplary embodiment, the automation software is configured to control any type of automated equipment that may be used during an automated application or process. For example, automated equipment 102 may include, but is not limited to, machinery, electrical equipment, computers, databases, and/or servers. Moreover, in the exemplary embodiment, user interface 108 enables a user to control, change, and/or update the automation software.

During operation, processor 106 runs automation software to operate automated equipment 102. More specifically, the automation software includes instructions that instruct each individual piece of automated equipment 102 to perform an automated application. However, if the automation software has a software environment that is defined using flat name space and automated equipment 102 is configured to operate using an equipment model, the automation software must be converted from flat name space to a suitable equipment model such that automated equipment 102 is compatible with the automation software.

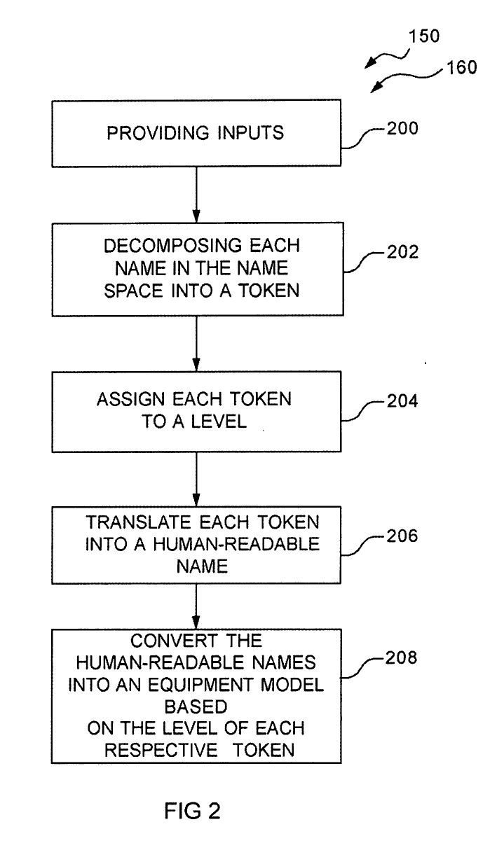

FIG. 2 is a flowchart 150 of an exemplary method 160 for converting the automation software from a flat name space to an equipment model. In the exemplary embodiment, computer 104 converts the flat name space used to define the automation software environment and the properties of any items defined by the flat name space into an equipment model including one or more levels. In this embodiment, processor 106 is configured to instruct computer 104 to convert the flat name space. In a particular embodiment, the flat name space is converted by a program embodied on a computer-readable medium.

Method 160 includes providing 200 inputs at user interface 108. In the exemplary embodiment, the inputs include a flat name space and/or item properties associated with the flat name space, a set of rules defining an equipment model, a set of rules for decomposing the name space, and/or a translation and/or mapping table for translating decomposed name space.

After providing 200 the inputs, computer 104 decomposes 202 each name in the flat name space into a corresponding token. More specifically, computer 104 applies a set of rules for decomposing the flat name space to decompose each name. In the exemplary embodiment, each name is decomposed into a pattern definition that is based on existing parsing rules. For example, the parsing rules may include, but are not limited to, delimiters, string lengths, and/or character patterns. Using the pattern definitions, each name is then further decomposed into the corresponding token.

Next, each token is assigned 204 to a level included in an equipment model hierarchy. The equipment model hierarchy is defined by the set of rules for defining the equipment model that was input 200 into user interface 108. In the exemplary embodiment, the equipment model has a six level hierarchy. Specifically, Level 1 pertains to an overall enterprise of the automated system; Level 2 pertains to an individual department of the enterprise; Level 3 pertains to area within the department; Level 4 pertains to a line within the area; Level 5 pertains to a unit on the line; and Level 6 pertains to a piece of equipment in the unit.

In the exemplary embodiment, the set of rules for decomposing the flat name space dictates how to decompose each name into the corresponding token and how to assign each token to a level in the equipment model hierarchy. In one embodiment, the set of rules for decomposing the flat name space may also use a combination of a token value, a token position, a token order, and an order of each token relative to the other tokens to further define and assign a level to each token. Accordingly, in one embodiment, a token that has been decomposed from a name that pertains to an area within a department of the automated system is assigned to Level 3, and a token that has been decomposed from a name that pertains to a piece of equipment is assigned to Level 6. Although the exemplary embodiment describes a hierarchy that includes six levels, as will be appreciated by one of ordinary skill in the art, the equipment model hierarchy may include any suitable number of levels.

After decomposing 202 each name in the flat name space, the resulting tokens are translated 206 into human-readable names. Specifically, computer 104 uses a translation table and/or a mapping table that was input into user interface 108 to translate 206 each token. The resulting human-readable name is converted 208 into an element of an equipment model based on the set of rules for defining the equipment model. For example, in one embodiment, a human-readable name that was translated from a Level 3 token would be converted into a portion of the equipment model that pertains to Level 3. In the exemplary embodiment, the rules for defining the equipment model are based on S95 specifications. In an alternative embodiment, the rules for defining the equipment model are based on any suitable specification.

Accordingly, each name in the flat name space is individually decomposed 202 into a token and translated 206 into a human-readable name. Each human-readable name is then converted 208 and used in an equipment model based on the level of the corresponding token. In the exemplary embodiment, computer 104 outputs a file that defines the newly converted equipment model. Computer 104 may also output a file that describes results of method 160.

In one embodiment, user interface 108 allows a user to modify and/or control the above-described method. For example, as described above, user interface 108 is used to input rules and translation tables. Accordingly, in one embodiment, user interface 108 allows the user to interactively create decomposition rules and configure the translation table for tokens with an immediate opportunity to view the results. Further, the user may also graphically create the name space decomposition rules. In an alternative embodiment, user interface 108 allows a user to resolve conflicts with the rules. Specifically, during the application of rules, ambiguous situations may occur that the defined rules cannot resolve. Accordingly, user interface 108 allows the user to add, modify and/or delete rules to correct an ambiguous situation. The modified rules are then applied to the flat name space in place of the original rules.

Further, in one embodiment, user interface 108 allows a user to modify the rules defining the equipment model and/or the definition of the model hierarchy. Moreover, in one embodiment, user interface 108 allows a user to modify a resulting equipment model prior to committing the equipment model to file.

In one embodiment, a method for converting a software environment defined using flat name space into an equipment model is provided. The method includes decomposing the flat name space into a plurality of tokens, and assigning each token to a corresponding level of a plurality of levels included in an equipment hierarchy. The method also includes translating each token into a human-readable name, and creating an equipment model based on the human-readable name and the corresponding level assigned to each token. In one embodiment, the equipment model is created using S95 specifications.

In one embodiment, each token is assigned to a level based on a token value, a token position, a token order, and/or an order of each token relative to other tokens of the plurality of tokens. Further, in one embodiment, each token is translated with a mapping table. In a further embodiment, the method includes providing a set of rules for decomposing the flat name space using a pattern definition including a delimiter, a string length, and/or a character pattern. In yet another embodiment, the method includes providing a set of rules for defining a hierarchy of the equipment model based on the plurality of levels. Moreover, in one embodiment, the method includes providing a user interface that is configured to modify steps of the method.

Accordingly, the above-described system and method facilitate converting a software environment defined using flat name space into an equipment model. As such, the above-described system and method enable equipment that is operated using an equipment model to compatibly function with equipment that is operated using flat name space. Resultantly, manufacturers and businesses that operate automated systems are able to update equipment without having to update an entire system. As such, the above-described system and method facilitate reducing costs and/or time associated with updating an automated system.

As used herein, an element or step recited in the singular and proceeded with the word “a” or “an” should be understood as not excluding plural said elements or steps, unless such exclusion is explicitly recited. Furthermore, references to “one embodiment” of the present invention are not intended to be interpreted as excluding the existence of additional embodiments that also incorporate the recited features.

Exemplary embodiments of systems and methods for converting flat name space to an equipment model are described above in detail. The systems and methods illustrated are not limited to the specific embodiments described herein, but rather, components of the system may be utilized independently and separately from other components described herein. Further, steps described in the method may be utilized independently and separately from other steps described herein.

While the invention has been described in terms of various specific embodiments, those skilled in the art will recognize that the invention can be practiced with modification within the spirit and scope of the claims.

What is claimed is:

1. A method for converting a software environment defined using flat name space into an equipment model, said method comprising:
decomposing the flat name space into a plurality of tokens;
assigning each token of the plurality of tokens to a corresponding level of a plurality of levels included in an equipment hierarchy;
translating each token into a human-readable name; and
creating an equipment model based on the human-readable name and the corresponding level assigned to each token.

2. A method in accordance with claim 1 wherein creating an equipment model further comprises creating the equipment model based on S95 specifications.

3. A method in accordance with claim 1 further comprising providing a set of rules for decomposing the flat name space using a pattern definition including at least one of a delimiter, a string length, and a character pattern.

4. A method in accordance with claim 1 wherein assigning each token of the plurality of tokens to a corresponding level of the plurality of levels further comprises assigning each token to a level based on at least one of a token value, a token position, a token order, and an order of each token relative to other tokens of the plurality of tokens.

5. A method in accordance with claim 1 wherein translating each token further comprises translating each token with a mapping table.

6. A method in accordance with claim 1 further comprising providing a set of rules for defining a hierarchy of the equipment model based on the plurality of levels.

7. A method in accordance with claim 1 further comprising providing a user interface that is configured to modify steps of the method.

8. An automated system comprising:
automated equipment; and
a processor configured to convert a software environment defined using flat name space into an equipment model usable by the automated equipment, wherein the processor converts the software environment by:
decomposing the flat name space into a plurality of tokens;
assigning each token of the plurality of tokens to a corresponding level of a plurality of levels included in an equipment hierarchy;
translating each token into a human-readable name; and
creating an equipment model based on the human-readable name and the corresponding level assigned to each token.

9. An automated system in accordance with claim 8 wherein the processor is further configured to create the equipment model by converting each translated token into an equipment model based on S95 specifications.

10. An automated system in accordance with claim 8 wherein the processor is configured with a set of rules for decomposing the flat name space using a pattern definition including at least one of a delimiter, a string length, and a character pattern.

11. An automated system in accordance with claim 8 wherein the processor is further configured to create the equipment model by assigning each token to a level based on at least one of a token value, a token position, a token order, and an order of each token relative to other tokens of the plurality of tokens.

12. An automated system in accordance with claim 8 wherein the processor is further configured to convert the software environment by translating each token with a mapping table.

13. An automated system in accordance with claim 8 wherein the processor is configured with a set of rules for defining a hierarchy of the equipment model based on the plurality of levels.

14. An automated system in accordance with claim 8 further comprising a user interface configured to modify the automated system.

15. A computer program embodied on a computer-readable medium, said computer program comprising at least one code segment configured to instruct a computer to convert a software environment defined using flat name space into an equipment model by:
decomposing the flat name space into a plurality of tokens;
assigning each token of the plurality of tokens to a corresponding level of a plurality of levels included in an equipment hierarchy;
translating each token into a human-readable name; and
creating an equipment model based on the human-readable name and the corresponding level assigned to each token.

16. A computer program in accordance with claim 15 wherein said computer program comprises at least one code segment configured to instruct a computer to convert each translated token into an equipment model based on S95 specifications.

17. A computer program in accordance with claim 15 wherein said computer program comprises at least one code segment comprising a set of rules for decomposing the flat name space using a pattern definition including at least one of a delimiter, a string length, and a character pattern.

18. A computer program in accordance with claim 15 wherein said computer program comprises at least one code segment configured to instruct a computer to assign each token to a level based on at least one of a token value, a token position, a token order, and an order of each token relative to other tokens of the plurality of tokens.

19. A computer program in accordance with claim 15 wherein said computer program comprises at least one code segment configured to instruct a computer to translate each token with a mapping table.

20. A computer program in accordance with claim 15 wherein said computer program comprises at least one code segment comprising a set of rules for defining a hierarchy of the equipment model based on the plurality of levels.
